(19) United States
(12) Patent Application Publication
(10) Pub. No.: US 2011/0178821 A1
(43) Pub. Date: Jul. 21, 2011

(54) MEDICAL DATA AND IMAGE SHARING

(76) Inventor: Douglas Smith, San Antonio, TX (US)

(21) Appl. No.: 12/853,221

(22) Filed: Aug. 9, 2010

(51) Int. Cl. G06Q 50/00; G06Q 10/00

(52) U.S. Cl. 705/3; 705/2

(57) ABSTRACT

A device and a method are disclosed including a unified format medical information and teleconferencing service (UFMITS) and client devices that communicate with such service, the UFMITS configured to obtain and view different format medical data, such as high resolution medical imaging data, convert the different formats to a unified format, and make such data available to the client devices via a single user interface. In operation, a medical agent, such as a surgeon, connects to the UFMITS, via a network, and requests medical data for a particular patient. The UFMITS sends medical information available about the particular patient to the medical agent in the unified format, enabling the medical agent to view all pertinent medical data using a single software interface. Furthermore, the medical agent may teleconference with other medical agents, via the UFMITS, to discuss such downloaded medical data, which are simultaneously downloaded to the other medical agents.

### TECHNICAL FIELD

This application relates generally to electronic data exchange. More specifically, this application relates to exchange of health-related electronic data and images for medical purposes.

### SUMMARY

In aspects of the present disclosures, an information server is disclosed including a network connection, a data services module, and a storage device. The data services module is configured to collect data from multiple data sources, where at least some of the multiple data sources have different data formats than other multiple data sources. The data services module is further configured to convert all data from the multiple data sources to a unified data format. The storage device is configured to store the data with the unified data format converted by the data services module.

In further aspects of the present disclosures, a client computing device is disclosed including a network connection and a medical data software application configured to download and view unified format medical information generated by an information server. The unified format medical information is generated from medical data obtained from multiple data sources, where at least some of the multiple data sources have different data formats than other multiple data sources.

In still further aspects of the disclosure, a method of providing information is disclosed including obtaining information from multiple information sources, where at least some of the multiple information sources have data formats that are different from the other multiple information sources. The method further includes converting the obtained information to unified format information and making the converted unified format information available to a client computing device.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example network computing environment for exchanging data between multiple healthcare agents;

FIG. 4 shows an example environment for a unified format medical information service configured to collect medical data in different formats, convert the different formats to a unified format, and enable client devices to obtain the unified format data;

FIG. 5 shows an example environment with a unified format medical information service including data services and teleconferencing services;

FIG. 6 shows a flow diagram for an example process of serving medical data; and

FIG. 7 shows a flow diagram for an example process of medical teleconferencing.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references medical images, such as X-ray images, it will be appreciated that the disclosure may be used with other types of medical data, such as CT images, lab test results, image annotations, and the like.

Briefly described, a device and a method are disclosed including a unified format medical information and teleconferencing service (UFMITS) and client devices that communicate with such service, the UFMITS configured to obtain and view different format medical data, such as high resolution medical imaging data, convert the different formats to a unified format, and make such unified format medical data available to the client devices via a single user interface. In an example typical operation, a medical agent, such as a surgeon, connects to the UFMITS, via a network, and requests medical data for a particular patient. The UFMITS sends medical information available about the particular patient to the medical agent in the unified format, enabling the medical agent to view all pertinent medical data using a single software interface. Furthermore, the medical agent may teleconference with other medical agents, via the UFMITS, to discuss such downloaded medical data, which are simultaneously downloaded to the other medical agents.

The modern medical practice resembles an advanced engineering environment with electronic devices, imaging systems, diagnostic instruments, communication systems, database systems, and many other advanced technologies employed to better meet the medical needs of patients. Each of the medical devices, particularly the diagnostic and imaging devices, produce large amounts of medical data and records that are often stored in different formats. A necessary part of the modern medical practice is the review of historical patient medical data prior to the prescription of new treatments. However, over the years, a patient may change physicians, visit different hospitals for different ailments, use the services of various imaging centers, labs, and other diagnostic facilities, each producing a different type of data record with a different format. The collection and use of such wide-spread and disparate data is a significant obstacle to medical agents, such as physicians, surgeons, and hospitals, in building a comprehensive and coherent medical profile for the patient. Data format disparity is a further obstacle to the communication and consultation of various medical agents involved in the care of a patient because each such medical agent may have access to only a portion of the medical records of the patient, not necessarily the same portion as the other medical agents. Some of the standards for maintaining and communicating healthcare information are discussed below.

The HIPAA (“The Health Insurance Portability and Accountability”) Act of 1996 was passed by the U.S. Congress to improve the efficiency and effectiveness of the U.S. health care system by the use of electronic data interchange. HIPAA safeguards the health insurance coverage for employees in the event of a change in job. HIPAA also requires the establishment of national standards for electronic health care transactions. It also attempts to address the security and privacy of health data. Therefore, HIPAA compliance is an important aspect of any electronic healthcare data service.

Health Level Seven (HL7) is an organization that participates in the development of healthcare standards. “HL7” is also used to refer to some of the specific standards created by the organization. HL7 provides a framework and related standards for the secure exchange, integration, sharing, and retrieval of electronic health information. For example, v2.x are standards, which support clinical practice and the management, delivery, and evaluation of health services, are some of the most commonly used healthcare standards in the world.

In medical imaging, electronic Picture Archiving and Communication Systems (PACS) have been developed to provide efficient storage, retrieval, and access to diagnostic images. Generally, electronic images and reports are transmitted digitally via PACS, eliminating the need to manually file, retrieve, or transport film packets. Software applications available from different vendors that can interpret and display PACS data generated at different sources present different user interfaces which are often incompatible. So, if a physician wants to view and compare two different images generated by two different PACS software from different vendors, the physician needs to load both PACS software applications on his computer and switch between the two to view and compare the two images. Such images are also generally not of diagnostic quality due, for example, to lack of sufficient resolution or contrast.

### Illustrative Operating Environment

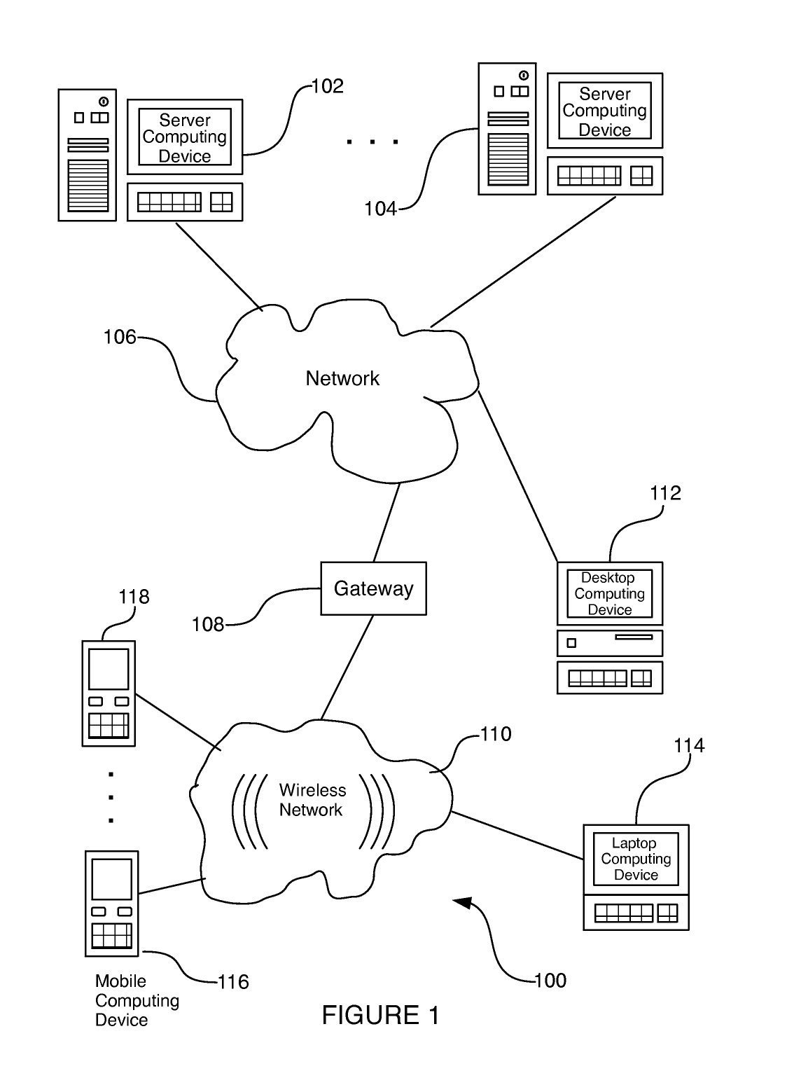

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

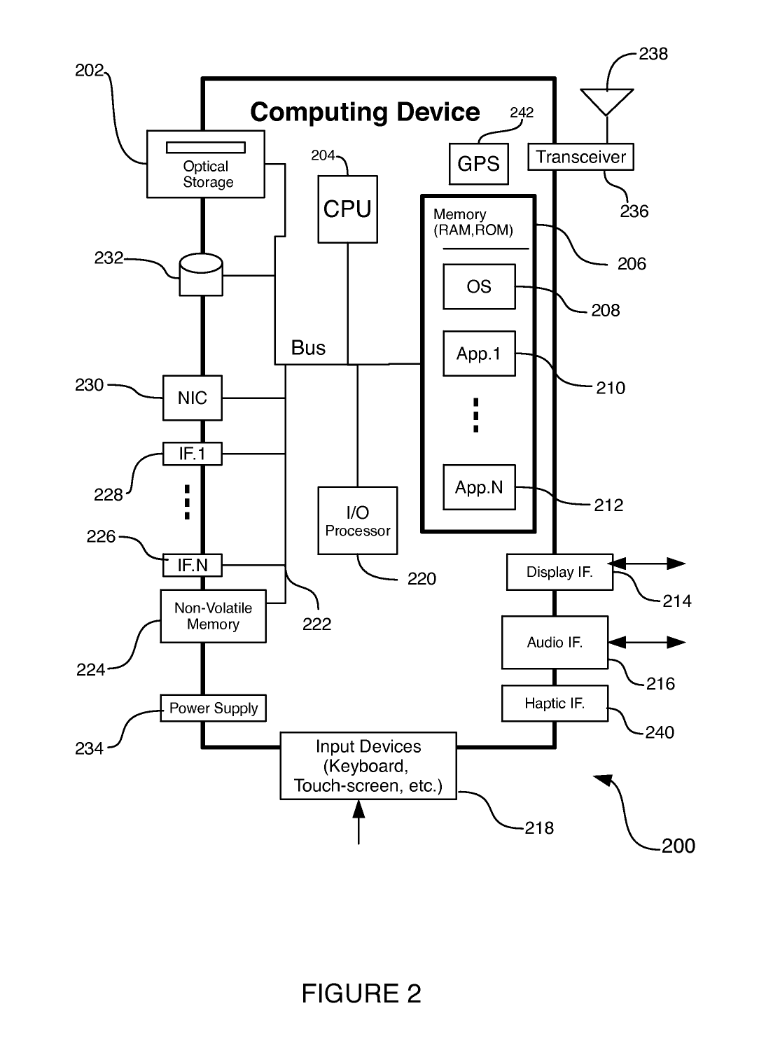

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. The computing device may include a mobile computing device such as a tablet PC, Apple Corporation's iPAD, a smartphone, and the like. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

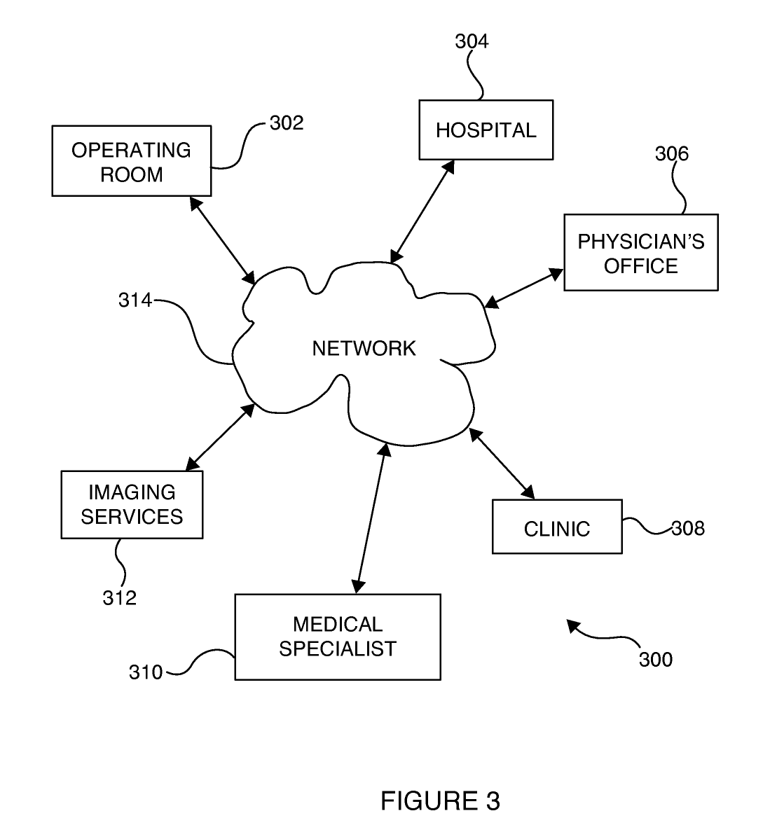

FIG. 3 shows an example network computing environment for exchanging data between multiple healthcare agents. In various embodiments, at a high conceptual level, network computing environment 300 includes network 314 linking various medical agents such as operating room 302, hospital 304, physician's office 306, medical clinic 308, medical specialist office 310, and imaging services 312. In various embodiments, network 314 is the Internet. Those skilled in the art will appreciate that network 314 may link more than one of each type of the above medical agents. Furthermore, it is understood that fewer medical agents or additional types of medical agents, such as health insurance companies or agents, Health Maintenance Organizations (HMO) administrators, and the like, may be linked via network 314, than those shown in FIG. 3.

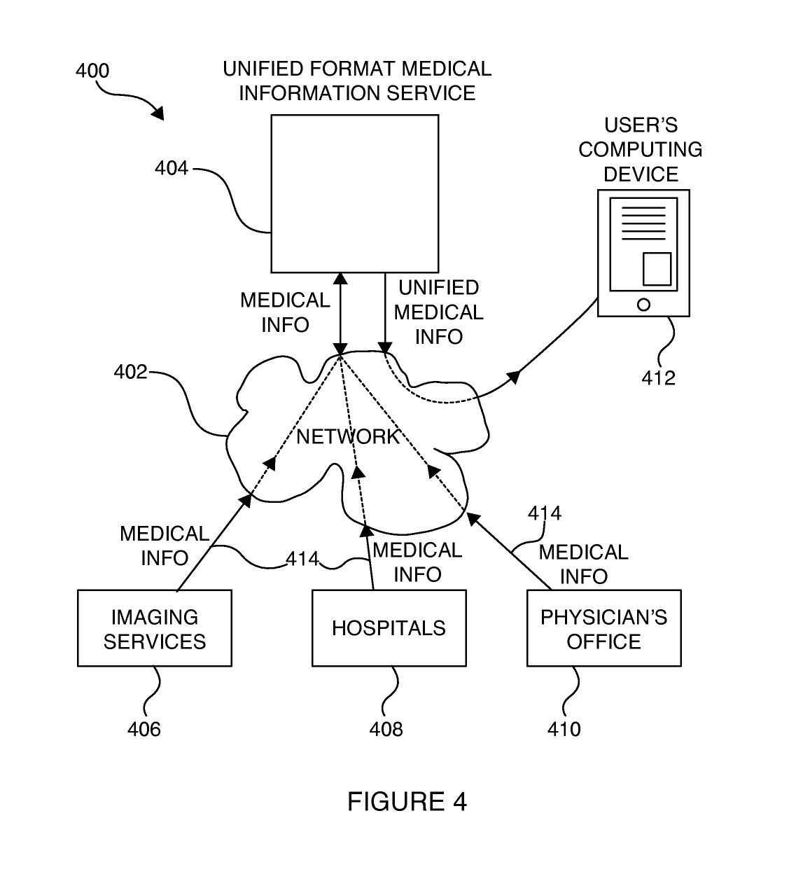

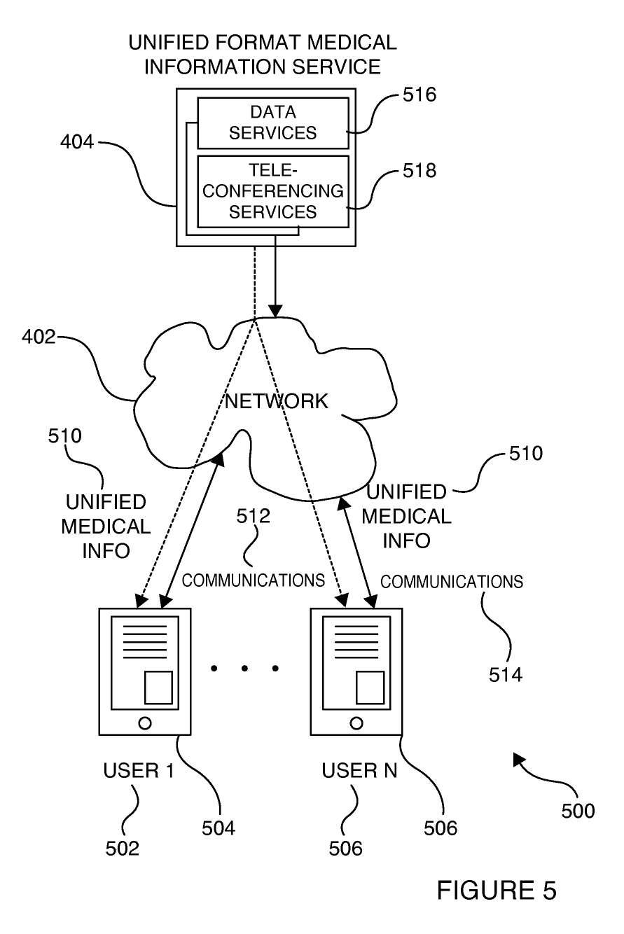

The exchanged data between the above-mentioned healthcare agents may include physician's notes, X-ray images, ultrasound images, Computer Tomography (CT) images, Computed Tomography angiography (CTA) images, lab test results, prior diagnosis, treatments, prescriptions, and the like. The interactions between the medical agents are further described in more detail with respect to FIGS. 4 and 5.

FIG. 4 shows an example environment for a unified format medical information service configured to collect medical data in different formats, convert the different formats to a unified format, and enable client devices to obtain and view the unified format data via a single user interface. In various embodiments, at a more detailed level, network computing environment 400 includes network 402, UFMITS (unified format medical information and teleconferencing service) 404, imaging services 406, hospitals 408, physician's office 410, and user's computing device 412. UFMITS 404 may be implemented as one or more server computing devices as described with respect to FIGS. 1 and 2.

Computing device 412 may be used by a user, who may be another physician, such as a surgeon, retrieving medical data for the particular patient from primary care physician's office 410, hospitals 408, and imaging services 406. Computing device 412 may include medical data software applications configured to communicated with UFMITS 404 to retrieve and display unified format medical information generated by UFMITS 404. Such medical data software applications installed on computing device 412 may be further configured to display the unified format medical information via a single user interface, so that the user of the computing device may freely retrieve and display desired medical information on one screen, or in one application environment, without having to open multiple different software applications to view various medical data and images. In one embodiment, the medical data software includes a web browser based application, while in another embodiment, the medical data software is an independent software application.

In operation, in various embodiments, a new physician for a particular patient may need medical data for the particular patient to make medical decisions about a new treatment for the patient. The new physician connects to UFMITS 404 to retrieve previous medical data about the particular patient from previous medical agents involved in the treatment of the patient, such as imaging services 406, hospitals 408, and the like. UFMITS 404 retrieves the requested data from the medical agents via links 414 to network 402. The requested data may be retrieved using standards, formats, and protocols specified or indicated, directly or indirectly, by HL7, PACS, HIPAA, and the like, and stored on a storage device associated with UFMITS 404. In the general case, such data obtained from the medical agents have various, potentially incompatible, formats and user interfaces. UFMITS 404 converts such disparate data with different formats to a single unified format and stores the results on a storage device for later use by the new physician through computing device 412 via a single user interface. Such data may also be transmitted to computing devices using standards, formats, and protocols specified or indicated, directly or indirectly, by HL7, PACS, HIPAA, and the like. UFMITS 404 preserves and/or enhances high resolution data, such as imaging data, for on-screen diagnostic by the new physician. The new physician can compare various data side-by-side on a screen of the computing device 412 for effective, accurate, and efficient diagnosis.

Those skilled in the art will appreciate that data may be formatted at many different levels. For example, in the communications field, the same data may be formatted at the physical layer as bits, at the data link layer as frames, and at the network layer as packets. Hence, even though medical data may use an underlying PACS format, at higher application levels, different formats may be used to store, organize, and display the same medical data by different PACS application software.

Additionally, physicians often need to consult with other physicians about diagnosis and/or proposed treatments. Real-time communications can significantly enhance treatment of patients in many situations, such as in the operating room, where time is often severely constrained and/or critical. Besides real-time communications, general medical consultation with multiple parties is often useful and may enhance the treatment quality of patients. The multiple parties may include the patient himself, other physicians, patient's family, insurance companies, and the like. During such consultation, the parties may need to look at the same medical data simultaneously to discuss different issues like a course of treatment. The consultation process is further described below with respect to FIG. 5.

FIG. 5 shows an example environment with a unified format medical information service including data services and teleconferencing services. In various embodiments, network computing environment 500 includes network 402, UFMITS 404 further including data services module 516 and teleconferencing services module 518, a first user 502 using computing device 504, and an N-th user 506 using computing device 508. In various embodiments, UFMITS 404 is configured to be accessed via a web browser interface through the Internet.

In operation, in various embodiments, first user 502, such as a physician, requests historical or other medical data of a particular patient from UFMITS 404. As described with respect to FIG. 4 above, UFMITS 404 retrieves the requested data from various medical agents and converts them to a unified format via a data services module 516 to be displayable via a single user interface on client computing devices 504 and 508. Those skilled in the art will appreciate that data services module 516 may be implemented as several modules, may be internal or external to UFMITS 404, and may be implemented as part hardware and part software. For example data services module 516 may be in the form of web services called remotely by UFMITS 404 to convert the retrieved data to the unified format. UFMITS 404 returns the unified format medical information 510 to first user 502 via computing device 504.

In one embodiment, user 502 may further request a conference call with one or more other medical agents, such as user 506. Teleconferencing services module 518 handles the conference call requests, connections, and communications. Once user 506 accepts an invitation to participate in the conference call, UFMITS 404 may download the same unified format medical information 510 sent to user 502 to computing device 508 for user 506's viewing. Those skilled in the art will appreciate that teleconferencing services module 518 may be implemented as multiple hardware and/or software modules and may be internal or external to UFMITS 404. For example, the communication functions of teleconferencing services module 518 may be implemented via another server distinct from, but in collaboration and coordination with UFMITS 404. Once the conference call is set up, user 502 and user 506 may consult together based on the medical data made available to both in the same unified format downloaded to computing devices 504 and 508, respectively. Communication messages 512 and 514 from users 502 and 506, respectively, are managed by teleconferencing services 518 through network 402.

In various embodiments, when a party to the conference call requests new data from UFMITS 404, teleconferencing services module 518 may notify the other parties in the communication session of the request for the new data make the same new data available to each party to maintain consistency of communications. Thus, the communication and data updates may be substantially synchronized between the multiple parties to the conference call. In various embodiments, UFMITS 404 may optionally record or log the communications from the teleconference call as new medical record for the particular patient.

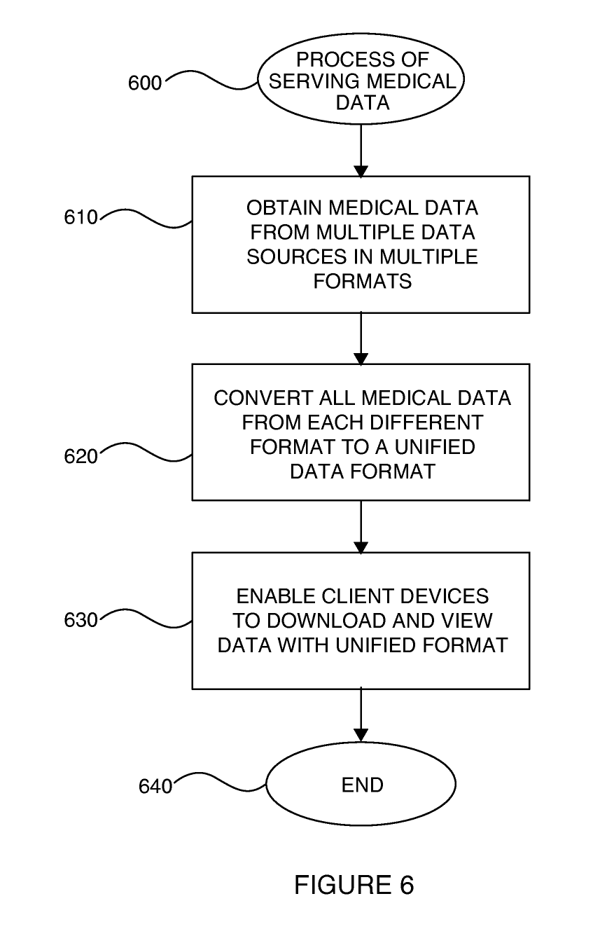

FIG. 6 shows a flow diagram for an example process of serving medical data. Process 600 proceeds to block 610 where medical data are obtained from sources such as previous physicians, hospitals, imaging centers, and the like. Often such medical data come in different incompatible formats, each requiring a different software application to read the data and view diagnostic images. The process proceeds to block 620.

At block 620, with reference to FIG. 5, data services module 516 of UFMITS 404 convert the obtained medical data having different formats to a single unified format for easy and complete access by users of UFMITS 404 via a single user interface. The process proceeds to block 630.

With continued reference to FIGS. 5 and 6, at block 630, user or client computing devices 504 and 508 are provided access to the unified format data via network 402 via a single user interface. Client computing devices 504 and 508 may request unified format medical information 510 from UFMITS 404 for review and diagnosis. In various embodiments, unified format medical information 510 have high enough resolution to be used for diagnosis purposes on computing devices 504 and 508.

Next, the process proceeds to block 650 and terminates.

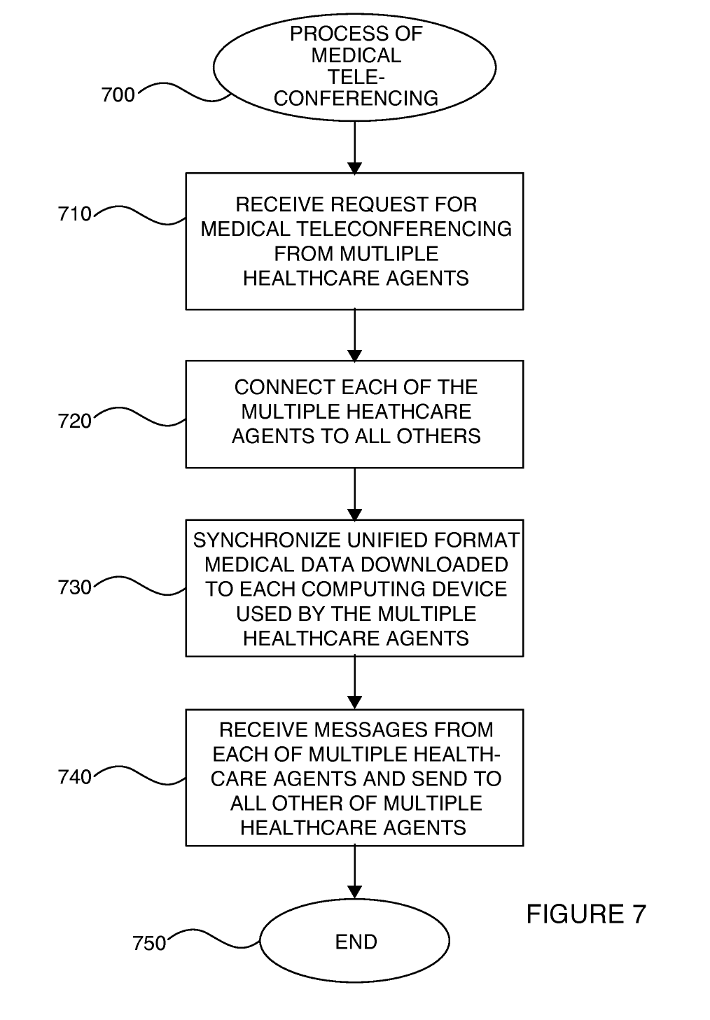

FIG. 7 shows a flow diagram for an example process of medical teleconferencing. With reference to FIGS. 5 and 7, process 700 proceeds to block 710, where UFMITS 404 receives a request for teleconferencing from user 502 to communicate with multiple other medical agents, such as user 506. The process proceeds to block 720.

At block 720, teleconferencing services module 518 of UFMITS 404 contacts and connects each of the requested multiple medical agents to a teleconference session with user 502. To set up and conduct such a communication session between multiple parties, any of a number of well-known communication protocols and techniques may be used. Next, the process proceeds to block 730.

At block 730, teleconferencing services module 518 of UFMITS 404 may coordinate, synchronize, and download unified format medical information 510 to each of the multiple parties in the teleconference session so that all parties communicate with each other based on the same medical information. In various embodiments, teleconferencing services module 518 may provide updated data to all parties in the communication session, for example, based on request from one party to obtain a new portion of data, such as another X-ray image or another medical record. The process proceeds to block 740.

At block 740, UFMITS 404 receives and sends messages, such as voice and/or video data, from each party in the communication session to all other parties, until the communication session ends on request from one or more parties.

At block 750, the process terminates.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems which perform the specified actions or steps, or combinations of special purpose hardware and computer instructions.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. An information server comprising:
a network connection;
a data services module coupled with the network connection and configured to collect data from multiple data sources, wherein at least some of the multiple data sources have different data formats than other multiple data sources, and further configured to convert all data from the multiple data sources to a unified data format; and
a storage device configured to store the data with the unified data format converted by the data services module.

2. The information server of claim 1 further comprising a teleconferencing module configured to set up and manage a conference call among multiple client devices coupled to the information server via the network connection.

3. The information server of claim 2, wherein the teleconferencing module is further configured to substantially synchronize the conference call with a download of the data with the unified data format to the multiple client devices.

4. The information server of claim 1, wherein the collected data comprises medical data.

5. The information server of claim 4, wherein the data collected from the multiple data sources are collected according to standards indicated by at least one of Health Insurance Portability and Accountability (HIPAA), Health Level Seven (HL7), and Picture Archiving and Communication Systems (PACS).

6. The information server of claim 5, wherein the medical data comprises at least one of a Computer Tomography (CT) scan image, a Computed Tomography angiography (CTA) image, an X-ray image, and an ultrasound image.

7. The information server of claim 1, wherein the multiple data sources comprise at least one of an imaging service, a hospital, a medical clinic, and a physician's office

8. The information server of claim 1, wherein the information server is configured to be accessed using a web interface via Internet.

9. A client computing device comprising:
a network connection; and
a medical data software application configured to download and view unified format medical information generated by an information server, wherein the unified format medical information is generated from medical data obtained from multiple data sources, wherein at least some of the multiple data sources have different data formats than other multiple data sources.

10. The client computing device of claim 9, wherein the client computing device comprises a tablet PC.

11. The client computing device of claim 9, wherein the network connection is wireless.

12. The client computing device of claim 9, wherein the medical data software application comprises a web browser based application.

13. The client computing device of claim 9, wherein the medical data software application comprises a user interface that enables a user of the client computing device to view information, obtained from the multiple data sources, in a single application environment.

14. The client computing device of claim 9, wherein the medical data software application is configured to connect with the information server to participate in a teleconferencing session with other client computing devices.

15. The client computing device of claim 14, wherein the teleconferencing session comprises voice and video communications substantially synchronized with the download of the unified format medical information.

16. A method of providing information, the method comprising:
obtaining information from multiple information sources, wherein at least some of the multiple information sources have data formats that are different from the other multiple information sources;
converting the obtained information to unified format information; and
making the converted unified format information available to a client computing device.

17. The method of claim 16, further comprising storing the unified format information on a storage device.

18. The method of claim 16, wherein the information comprise medical information.

19. The method of claim 18, wherein the information comprises diagnostic imaging.

20. The method of claim 18, wherein the diagnostic imaging is compatible with Picture Archiving and Communication Systems (PACS).
